(19) United States
(12) Patent Application Publication
(10) Pub. No.: US 2026/0299958 A1
(43) Pub. Date: Oct. 1, 2026

(54) MEMORY DEPENDENCE PREDICTION

(71) Applicant: Advanced Micro Devices, Inc., Santa Clara, CA (US)

(72) Inventor: Hanbing Liu, Austin, TX (US)

(73) Assignee: Advanced Micro Devices, Inc., Santa Clara, CA (US)

(21) Appl. No.: 19/096,299

(22) Filed: Mar. 31, 2025

(51) Int. Cl. G06F 9/38; G06F 9/30; G06F 9/32

(52) U.S. Cl. CPC G06F 9/3838; G06F 9/30043; G06F 9/324

(57) ABSTRACT

The present disclosure relates to systems and methods for memory dependency prediction. The systems and methods include maintaining, by processing circuitry, a set of store instructions recently dispatched for execution, each store instruction having a type and one or more attributes and in response to a load instruction that has a first type and a first set of one or more attributes that corresponds to a type and attributes for a store instruction in the set of store instructions recently dispatched for execution, indicating, by the processing circuitry, a memory dependency between the load instruction and the store instruction.

### BACKGROUND

Memory dependence prediction is a technique employed to take advantage of microprocessors that are able to execute load and store operations out of program pipeline order. To execute a load or store operation out of order, an evaluation has to be performed to determine the likelihood that an operation is dependent on a result from another operation that has not yet been executed. Dependent load and store operations are kept in order, while non-dependent operations can be executed out of order.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an example diagram of a computing system for use in memory dependence prediction;

FIG. 2 is a flow diagram for performing memory dependence prediction;

FIGS. 3A and 3B are example diagrams of load and store entries for use in memory dependence prediction;

FIG. 4 is a flow diagram for performing memory dependence prediction; and

FIG. 5 is a flow diagram for performing memory dependence prediction; and

FIG. 6 is an example diagram of a data structure for use in memory dependence prediction.

### DETAILED DESCRIPTION

Described herein are examples of methods and systems for memory dependence prediction using tracking of data addressing. The tracking may be provided in some implementations by creating a data structure that includes at least a field indicating a type of data addressing used in an instruction and a field for specified attributes associated with that type of data addressing for that instruction. Implementing the tracking structure may reduce or eliminate the need to have multiple separate tracking structures for each type of data addressing being executed within an instruction pipeline or program counter, which may enable providing a unified tracking in some implementations. The tracking may include storing in one or more tables (or other suitable data structure) information regarding a set of store instructions that have recently been dispatched for execution. The table(s) can include prior store instructions, with each of the store instructions having one or more fields (or other suitable data structure) for a type of data addressing and one or more fields (or other suitable data structure) for specified attributes associated with that type of data addressing. The table(s) may include store instructions having more than one type of data addressing, rather than separating store instructions using different data addressing techniques into different tables. Load instructions each reference a data address using a type of data addressing that corresponds to the types of data addressing used for store instructions, such that there are multiple different types of load instruction data addressing types, and each would include one or more fields for specified attributes associated with the type of data addressing. When a load instruction is decoded or otherwise received, the unified tracker can be used for memory dependence prediction by comparing the data address information for the load instruction to the data address information for the set of store instructions. In short, the unified tracker establishes a classification structure that can be referenced against load and/or store instructions formatted using different types of data addressing. A dependence prediction will be based on whether the type and attributes for the load instruction match the type and attributes for one of the saved store instructions.

Over time computing devices, particularly microprocessors, have become more complex with advanced capabilities, which has opened the door to processing data in a variety of manners. One such advancement is the ability for microprocessors to be able to process instructions in parallel. Parallelism has enabled out of order processing for load and store instructions to be implemented to increase the efficiency of microprocessors. Load and store instructions can be executed using different “in order” and/or “out of order” execution methodologies, each having their advantages and drawbacks. As an example, a conservative load and store execution methodology could include executing load and store instructions in order as they occur within an instruction pipeline, which may result in slower execution but would eliminate memory order violations. In contrast, an aggressive methodology could include, assuming that each instruction is independent from any other instruction positioned ahead of it in the instruction pipeline. The aggressive approach could be faster execution, but would be more susceptible to memory order violations, which would cause delays when those violations have to be resolved. Memory dependence prediction methodologies can offer a compromise between the conservative and aggressive approaches. Memory dependence predictions involve evaluating whether a given instruction is likely to be dependent (e.g., accessing the same memory location) upon another instruction that is positioned prior in the instruction pipeline. Based on the memory dependence prediction evaluation, the instruction can be executed out of order or delayed until after the dependent instruction has executed. In other words, if there is dependency predicted, the instruction will wait until the dependent instruction is executed, otherwise if not dependent, that instruction can be executed out of order.

As microprocessors capabilities continue to advance, so do the number of memory addressing structures with corresponding memory dependence prediction methodologies. Each new memory addressing structures and/or memory dependence prediction methodology adopted by a computing device, often requires the inclusion of different files, tables, trackers, etc. for implementing that memory dependence prediction methodology. For example, if a microprocessor architecture implements two types of memory addressing structures, there could be two or more separate data structures for performing the memory dependence prediction, one for each memory addressing structure. For example, a prediction controller can maintain a first structure (e.g., a memory file) to record addressing patterns for dispatched stores, a second structure (e.g., stack tracking file) to record stack offsets for dispatched stores, and a third structure (e.g., relative to instruction pointer (rip) relative or program counter relative) to record rip-relative loads for dispatched stores. A data structure for a symbolic file addressing structure (or Memfile) can record addressing pattern, base+index+scale+displacement for dispatched stores, while a data structure for a stack tracker tracks stack offset for dispatched stores, and lastly a data structure for rip relative could store an address pointer (e.g., rip+displacement) or a hash value of said address pointer. Thereafter, when a load is dispatched, each of the data structures for the Memfile and stack tracker can be referenced, in view of the base/index/displacement and/or predicted stack offset, to determine which recent store appears to be to the same address.

Having multiple files for performing memory dependence prediction adds complexity to the memory dependence prediction process. For example, continuing the load and store example, each of the files for each type of memory addressing structure would need to be used to evaluate each received instruction for dependency. Thereafter, a resolution would need to be performed to determine which result (from each memory dependence prediction method) is the correct and/or more accurate result. As more memory dependence prediction methodologies are added, the greater the increase to such complexity is caused. Such complexity can contribute to decreased performance, larger chip area, power requirements, timing overhead, and more.

In some examples, a method for memory dependency prediction is provided, the method includes maintaining, by processing circuitry, a set of store instructions recently dispatched for execution, each store instruction having a type and one or more attributes and in response to a load instruction that has a first type and a first set of one or more attributes that corresponds to a type and attributes for a store instruction in the set of store instructions recently dispatched for execution, indicating, by the processing circuitry, a memory dependency between the load instruction and the store instruction.

In some examples, the indicating the memory dependency is performed using a memory dependence prediction methodology associated with the first type.

In some examples, the set of store instructions recently dispatched for execution includes a list of stores having multiple types of memory addressing structures.

In some examples, the first type is associated with a symbolic file addressing structure and the first set of one or more attributes are at least a base register, an index register, a scale, and a displacement.

In some examples, the first type is associated with a stack addressing structure and the first set of one or more attributes is at least an offset.

In some examples, the first type is associated with a rip relative addressing structure and the first set of one or more attributes is at least a target address hash.

In some examples, the maintaining the set of store instructions recently dispatched for execution includes a first table having a first plurality of store instructions that have most recently been dispatched and a second table having a second plurality of store instructions that have most recently been removed from the first table.

In some examples, the indicating the memory dependency includes matching the first set of one or more attributes to the store instruction within the first table having the first plurality of store instructions and renaming the store instruction within the first table of the set.

In some examples, the indicating the memory dependency includes matching the first set of one or more attributes to the store instruction within the second table having the second plurality of store instructions and retrieving data from a store queue entry using information from the second table.

In some examples, an system is included, the system including at least one storage medium having encoded thereon executable instructions, at least one processing unit configured to interact with the executable instructions and configured to maintain a set of store instructions recently dispatched for execution, each store instruction having a type and one or more attributes and in response to a load instruction that has a first type and a first set of one or more attributes that corresponds to a type and attributes for a store instruction in the set of store instructions recently dispatched for execution, indicate a memory dependency between the load instruction and the store instruction.

In some examples, the at least one storage medium includes at least one of registers, cache, and random-access memory.

In some examples, the indicating the memory dependency is performed using a memory dependence prediction methodology associated with the first type.

In some examples, the set of store instructions recently dispatched for execution includes a list of stores having multiple types of memory addressing structures.

In some examples, the maintaining the set of store instructions recently dispatched for execution includes a first table having a first plurality of store instructions that have most recently been dispatched and a second table having a second plurality of store instructions that have most recently been removed from the first table.

In some examples, the indicating the memory dependency includes matching the first set of one or more attributes to the store instruction within the first table having the first plurality of store instructions and renaming the store instruction within the first table of the set.

In some examples, an apparatus is included, the apparatus including at least one circuit arranged to maintain a set of store instructions recently dispatched for execution, each store instruction having a type and one or more attributes and in response to a load instruction that has a first type and a first set of one or more attributes that corresponds to a type and attributes for a store instruction in the set of store instructions recently dispatched for execution, indicate a memory dependency between the load instruction and the store instruction.

In some examples, the indicating the memory dependency is performed using a memory dependence prediction methodology associated with the first type.

In some examples, the set of store instructions recently dispatched for execution includes a list of stores having multiple types of memory addressing structures.

In some examples, the maintaining the set of store instructions recently dispatched for execution includes a first table having a first plurality of store instructions that have most recently been dispatched and a second table having a second plurality of store instructions that have most recently been removed from the first table.

In some examples, the circuit is one of one or more central processing units (CPUs), one or more processor chiplets of the one or more CPUs, and one or more cores of a processor chiplet.

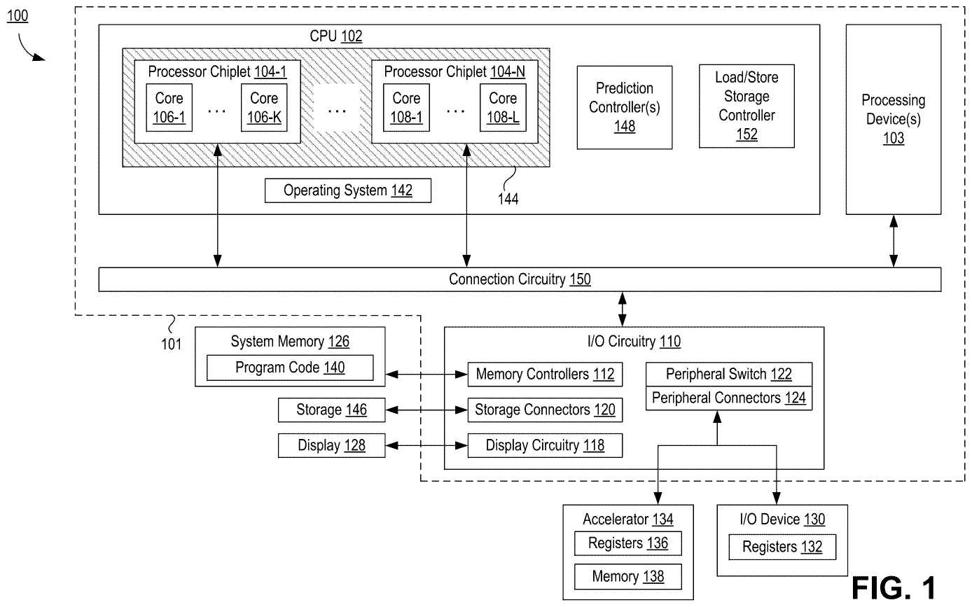

FIG. 1 illustrates one exemplary implementation of a computer system 100 configured to implement the techniques described herein, although others are possible. It should be appreciated that FIG. 1 is intended neither to be a depiction of necessary components for a computer system 100 to operate in accordance with the principles described herein, nor a comprehensive depiction.

Computer system 100 can be, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. Computer system 100 can comprise at least one central processing unit (CPU) 102, one or more processing devices 103 (e.g., graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), connection circuitry 150, I/O circuitry 110, system memory 126, at least one I/O device 130, at least one accelerator 134, storage 146 (e.g., computer-readable storage media), and/or at least one display 128. In some examples, the CPU 102, processing devices 103, connection circuitry 150, and I/O circuitry 110, are coupled to (e.g., mounted on) a printed circuit board (e.g., motherboard) 101.

CPU 102 enables processing of data and execution of instructions. The data and instructions can be stored on system memory 126, storage 146, and/or internal memory (not shown) of the CPU 102. In some examples, the CPU 102 includes one or more processor chiplets 104-1 . . . 104-N, which may be disposed on or over a package substrate 144. In some examples, the processor chiplets 104 can communicate with each other via interconnects routed through or on the package substrate 144 (e.g., through an interposer layer disposed between the package substrate 144 and the processor chiplets 104). In some examples, each of the processor chiplets 104 includes one or more cores (106, 108). Different processor chiplets 104 can have the same or different numbers of cores (106, 108). In the example of FIG. 1, processor chiplet 104-1 has K cores 106-1, 106-2, . . . 106-K, and processor chiplet 104-N has L cores (108-1, 108-2, . . . 108-L). The cores within an individual processor chiplet (e.g., cores 106-1, 106-2, . . . 106-K) can be homogeneous or heterogeneous. Likewise, the cores on different processor chiplets (e.g., cores 106-1 and 108-1) can be homogeneous or heterogeneous. The cores 106, 108 can include a front-end portion having instruction fetch, decoder, dispatcher, etc. and a back-end having an out-of-order execution unit, and load and store units.

In the example of FIG. 1, the CPU 102 is configured to execute instructions of an operating system 142 and/or instructions (e.g., program code 140) of one or more applications or other programs. In some examples, the functionality of the program code may be implemented by one or more processing devices 103, one or more CPUs 102, one or more processor chiplets of a CPU 102, and/or one or more cores of a processor chiplet.

The data and instructions stored on any of the computer-readable storage media (e.g., system memory 126, storage 146, accelerator memory 138, internal or external caches of the CPU 102, etc.) can comprise computer-executable instructions implementing any suitable functionality. For example, load and store operations in a program, compiler, etc.

In some examples, connection circuitry 150 communicatively couples CPUs 102 with each other, with processing devices 103, and/or with external caches (e.g., level-2 (L2) cache, level-3 (L3) cache, etc.). Additionally, or alternatively, the connection circuitry 150 can communicatively couple the CPUs 102 with I/O circuitry 110, which communicatively couples system memory, storage devices, and peripheral devices to each other and (via the connection circuitry 150) to the CPUs 102. The connection circuitry can couple the CPUs 102, external caches, and I/O circuitry 110 using any suitable network topology (e.g., a front-side bus, a back-side bus, etc.), and the coupled components can send and receive messages via the connection circuitry using any suitable communication protocol. In some examples, portions of the connection circuitry 150 can be integrated into the CPU(s) 102 and/or processing devices 103.

In some examples, I/O circuitry 110 includes one or more memory controllers 112, one or more storage connectors 120, display circuitry 118, one or more peripheral connectors 124, and a peripheral switch 122. The memory controller(s) 112 can be configured to control the flow of data to and from the system memory 126. The storage connector(s) 120 can be configured to control the flow of data to and from the storage 146. The display circuitry 118 can be configured to send visual data (e.g., user interface data, image data, video data, etc.) to the display 128, which can be configured to display the visual data. In some examples, the display circuitry 118 can also be configured to receive data representing user input from the display 128 (e.g., in cases where the display 128 includes a touchscreen). In some examples, portions of the I/O circuitry 110 can be integrated into a motherboard and/or motherboard chipset (e.g., I/O circuitry 110) of the computer system 100.

Each of the peripheral connectors 124 may be configured to physically connect and communicatively couple the I/O circuitry 110 to a peripheral device. Any suitable type of peripheral device can be connected to a peripheral connector 124 including, without limitation, an I/O device 130 (e.g., an input device, output device, or input/output device), an accelerator 134, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input/output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the computer system 100 to communicate via wires and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 132. In some examples, the I/O circuitry 110 can control the operation of an I/O device 130 by writing suitable data to one or more of the I/O device's registers, and/or can monitor the status of an I/O device 130 by reading the contents of one or more of the I/O device's registers.

Some non-limiting examples of an accelerator 134 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 134 includes one or more registers 136 and memory 138. In some examples, the I/O circuitry 110 can control the operation of an accelerator 134 by writing suitable data to one or more of the accelerator's registers, and/or can monitor the status of an accelerator 134 by reading the contents of one or more of the accelerator's registers.

The peripheral switch 122 can be configured to switch packets sent to or from the peripheral devices. Any suitable type of peripheral connector(s) 124 and peripheral switch 122 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

Continuing with FIG. 1, in some examples, the computer system 100 can comprise at least a prediction controller 148. The prediction controller 148 can be part of the CPU 102 architecture or operation in conjunction with the CPU 102 (e.g., via connection circuitry 150). For example, a prediction controller 148 can be part of a dispatcher block in each of the cores 106,108. The prediction controller 148 is responsible for making accurate dependency predictions such that instructions are only executed in parallel or out of order when there is not a dependency on another instruction earlier in the program. The prediction controller 148 can be configured to implement memory dependency predictors (MDPs) to analyze the memory or register addresses of store operations and load operations (or references as store(s) and load(s)) to predict whether a load has a dependency from a recent store. The prediction controller 148 can formulate a dependency prediction using a combination of historical access information for previous store and load accesses, load and store patterns, data alignment, etc. In some examples, the prediction controller 148 can also determine when an instruction can be subject to renaming or when data should be accessed from memory.

In some examples, the computer system 100 can comprise load/store storage controller 152 including one or more data structures related to the storage of store operations and/or load operations. For example, the data structure(s) in the load/store storage controller 152 can include an active store table for storing loads and/or stores that have been recently or will be executed shortly for supporting memory dependence prediction. In another example, the data structure(s) in the load/store storage controller 152 can include store queue entries to store data associated with various stores. These data structures can include information about the stores/loads including but not limited to store register numbers (SRN), addressing format, dependency information, etc. The load/store storage controller 152 can be part of the CPU 102 architecture or operation in conjunction with the CPU 102 (e.g., via connection circuitry 150). For example, a load/store storage controller 152 can be in each of the cores 106,108.

As described above computer system 100 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

In some examples, computer system 100 provides elements to implement systems and methods for memory dependence prediction for out of order instruction executions. When instructions for a program are being executed in a computing device, for example computer system 100, there can be multiple stages involved. These stages can include a processing component (e.g., one or more CPUs 102, one or more processor chiplets of a CPU 102, and/or one or more cores of a processor chiplet.) fetching the instruction from system memory 126 and/or storage 146, decoding the instruction to determine actions required, executing the operation specified in the instruction, performing a memory access to read or write to or from system memory 126 and/or storage 146, and storing the result back to a register. When implementing out of order processing (or parallelism), multiple instructions can be processed at once (e.g., one or more CPUs 102, one or more processor chiplets of a CPU 102, and/or one or more cores of a processor chiplet.) to increase the execution speed. Inefficiencies can occur, however, when executing out of order instructions in instances in which an instruction being processed depends on results of a previous instruction. Therefore, memory dependence prediction is critical to ensure efficient processing when executing instructions out of order.

Memory dependence prediction can be implemented at different levels within the computer system 100. For example, memory dependence prediction can be used when executing load and store instructions to improve memory latency. Similarly, different programs and application can be executed using parallelism. For example, programs written in assembly language can operate with an improved efficiency using out of order execution and memory dependence execution. Some assembly languages use a combination of store and load for memory or register accesses to execute a program. The prediction controller 148 can be used to perform memory dependence prediction (e.g., using MDPs) for handling dependencies between loads and stores. For example, if a store occurs before a load (e.g., within a program), and the load depends on the value (e.g., a value within a same register address) provided by the store, then the processing component(e.g., one or more CPUs 102, one or more processor chiplets of a CPU 102, and/or one or more cores of a processor chiplet.) must ensure that the load uses the correct data to avoid stalls and/or re-execution.

The prediction controller 148 can implement different methods for memory dependence prediction, including but not limited to store set predictors, address comparison predictors, stride predictors, etc. In some instances, the prediction controller 148 can perform a content-addressable memory (CAM) operation memory dependence prediction. CAM or camming is an associative memory process that is used to compare load or store data against a data structure (e.g., a table, array, etc.) of stored stores, and returns the address of matching data. In associative cache memory, both address and content can be stored side by side, such that when the address matches, the corresponding content can be fetched from cache memory. In some implementations, the SRN field can be implicit, such that the position of an entry in a data structure (or array) is the SRN and the entries do not require a storage bit in the entry data structure. As a result, there is no need to read out the SRN attribute of entry when a match is identified. For example, when entry X is identified as the best match, there is no need to read out SRN X, instead the SRN is X.

In some examples, the prediction controller 148 can create and/or maintain a store set. A store set includes a set of memory locations that have recently been written to using store operations or instructions. The store set can be used to predict whether a load instruction might be reading from a location that was recently updated by a store instruction, as discussed in greater detail herein.

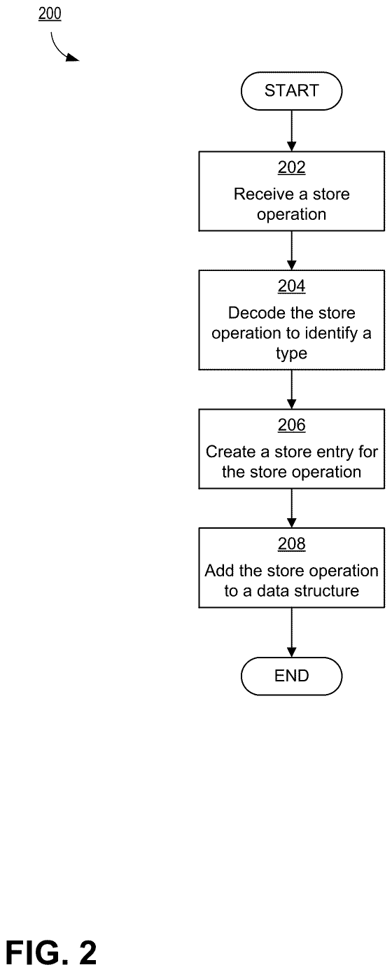

For purposes of discussion, FIGS. 2-6, may be discussed with respect to use of the CPU 102, however, any combination of processing components can be used in accordance with the present discussions. For example, one or more CPUs 102, one or more processor chiplets of a CPU 102, and/or one or more cores of a processor chiplet without departing from the scope of the discussion. Similarly, storage of loads and stores can be performed using any combination of storage, for example, registers, memory, storage, etc. without departing from the scope of the discussion.

Referring to FIG. 2, an example flowchart showing an example method for creating and/or maintaining a data structure including a list of store instructions that have recently been dispatched for execution is depicted. Although the steps of FIG. 2 are discussed with respect to the prediction controller 148, any combination of elements within computer system 100 could be utilized to implement the steps. Initially, a CPU 102 can fetch the next instruction from a program counter or other pipeline, decode the instruction, and then execute the instruction. The instructions can include any combination of store and load instructions. The prediction controller 148 can operate with the CPU 102 to perform the steps in FIG. 2, as it relates to the store instructions.

At step 202, a store operation is received or otherwise decoded by the prediction controller 148. For example, a store instruction can be received from the CPU 102 as the instruction pipeline is populated and/or executed. An example of a store instruction can be MOV [RBX], RAX, which stores the value in the RAX register into the memory location pointed to by the RBX register. The store operation received by the prediction controller 148 can be an instruction that has already been executed, is currently being executed, is queued to be executed (e.g., dispatched), and/or will be executed shortly.

At step 204, the store operation is decoded or otherwise analyzed, by the prediction controller 148, to identify a type of addressing being used in the store operation. Different types of addressing modes can be used to dictate how the operands of a store instruction are access. For example, in assembly, types can include immediate addressing, register addressing, direct addressing, indirect addressing, indexed addressing, base plus offset addressing, relative addressing, register indirect addressing, scaled indexed addressing, etc. Memory dependence prediction can be performed on each type of addressing, or multiple types combined. The type of addressing being performed for a given store instruction can be identified or otherwise derived using any combination of methods. The store instruction can be parsed, by the prediction controller 148 (or an instruction decoder unit), to identify the operands (e.g., source and destination) being used including any additional attributes that can be identified (e.g., base register, index register, offset, scale, displacement, etc.). For example, the store of MOV [RBX], the data operand is RAX and the value in the RAX register us copied to a memory location specified by RBX register. The RBX is the “base” register of the address calculation. In this example, the command could be identified as register addressing because both operands are registers (e.g., RBX and RAX). In another example, mor[rbx+rcx<<4+13], RBX is base register, RCX is the index, the scale factor is 4, the displacement is 13, and RAX is the data operand.

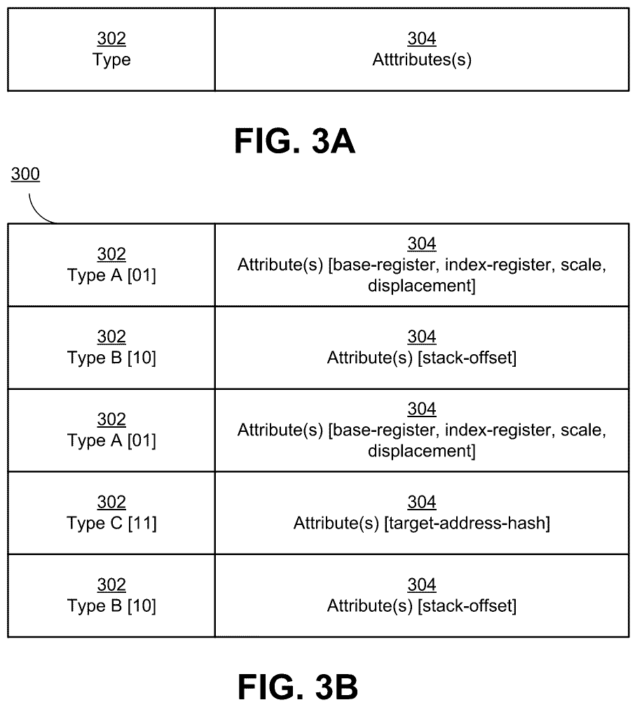

At step 206, a store entry is created, by the prediction controller 148, for the store operation. In some examples, the store entry can be created based on the type and attributes identified in step 204. The store entry can be created using any combination of fields that would identify the type of addressing mode and the attributes associated with that store. In some implementations, a store includes two entries, including an instruction PC hash and a type. For example, for a store [1000], the RAX instruction is at location 2000, and the hash of 2000 is saved in the entry. The other entry is a type specific entry. For example, a rip-relative store can be Type C and a target-address hash. FIGS. 3A and 3B show examples of a format for store and/or load entries. In some examples, when younger loads are able to get data from the store directly (without first waiting for the store to written to memory, and read from memory back) an entry can be created, to create a subset of stores.

In some examples, when a store entry is created, the information being input into the fields can be compressed to fit the format of the store entry. This may occur in instances when a store operation includes operand and/or register information having a bit value greater than the number of bits allocated for an attribute field, the operand and/or register information can be further compressed such that it can be included as a store entry within the data structure. For example, a relative to instruction pointer (rip) store operation (e.g., MOV [RIP+1000], R10) can have a pointer value that is greater than an attributes field (e.g., 20-bits) for the store entry because a target address could be a 64-bit value. To ensure that the 64-bit target address value can be stored in the store entry, the 64-bit value can be compressed down to the desired size (e.g., 20-bits). The compression can be achieved using any combination of techniques. For example, the 64-bit value can be compressed using a data hash to create a target address hash that will fit within the attributes field. In some implementations, compression (e.g., hashing) can be performed to find a good compromise between area needed, timing requirements, and/or accuracy requirements (false positive).

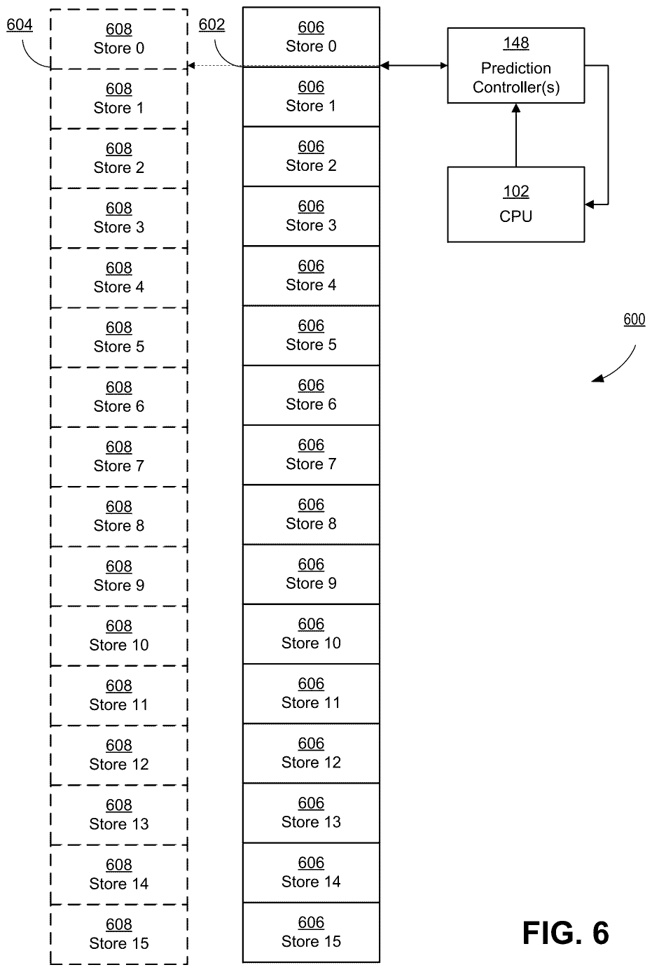

At step 208, the store entry is added, by the prediction controller 148, to a data structure to create the set of store entries. The data structure can include any combination of structures, for example, a table, array, database, etc. Similarly, the data structure can be stored in any combination of cache and/or memory. In some implementations, the entries are saved in flops (state holding element build of transistors). The data structure can be created and maintained by adding a predetermined number of store entries to its structure. The predetermined number can be based on a predetermined number (e.g., 16 entries) or it can be dynamic based on available storage. FIGS. 3A, 3B, and 6 show examples of data structures maintain a list of recently accessed store entries.

In some examples, the data structure created, as described in FIG. 2, can be a two-level data structure having a first data structure and a second data structure. The first data structure can include the most recent store entries. For example, for a 16-entry data structure, the last 16 store entries would be included in the first data structure. The second data structure can include the store entries most recently removed from the first data structure. For example, for a 16-entry data structure, the last 16 store entries that were moved out of the first data structure would be included in the first data structure. Each of the first and second data structures can include any number of predetermined or dynamically allocated number of entries. An example of a two-level data structure is discussed in greater detail with respect to FIG. 6.

Referring to FIGS. 3A and 3B, in some examples, the prediction controller 148 can maintain a data structure 300 including stores and/or loads for all the different MDPs being used by the computer system 100. The data structure 300 can include specialized entry format including at least a type field 302 and an attributes field 304 for both stores and loads.

FIG. 3A shows an example store entry including the type field 302 and the attributes field 304. The store entry can be implemented using any combination of bits. For example, the type field 302 can be a 2-bit field and the attributes field 304 can be a 20-bit field. The usage of a 20-bit field can be a compromise between area, timing, and accuracy. Although depending on the architecture being used, the number of bits the entry can vary, for example, for systems using 32-bit or 64-bit entries. Similarly, the number of bits reserved for the type field 302 can vary depending on the number of MDPs being implemented. For example, if 1-4 distinct MDPs are being implemented by the computer system 100, then a 2-bit field is sufficient, however, if 5-8 distinct MDPs are being implemented, then a 3-bit field would be needed, and so forth.

The attributes field 304 can be designed to receive the attributes or parameters associated with a particular type of MDP. For example, the MDPs can include a memory file (or memfile) prediction method using attributes for i) base-register, ii) index-register, iii) scale, iv) displacement; a stack tracker prediction method using attributes for a i) stack-offset, and a rip-relative prediction method using attributes for a i) target-address-hash. In this example, each of the prediction types can be associated with a value in a 2-bit type. For example, bits ‘01’ can be used for memory file prediction, bits ‘10’ can be used for stack prediction, and bits ‘11’ can be used for rip-relative prediction. Similarly, each set of attributes associated with a given type can be populated within the attribute field 306. Continuing the above example, the attribute field 306 for the memory file (or memfile) prediction method could include i) base-register, ii) index-register, iii) scale, and iv) displacement; the attribute field 306 for the stack tracker prediction method could include a stack-offset, and the attribute field 306 for the rip-relative prediction method could include a target-address-hash. In this example, each of the prediction types can be associated with a value in a 2-bit type. Regardless of the content of the attribute field 306, the values are used for determining an effective address for accessing data in the system memory 126 and/or the storage 146. In some examples, the load entry can be formatted in a same format as the store entry, as depicted in FIG. 3A. In particular, the load entry can have a type field 302 and an attributes field 304.

Referring to FIG. 3B, in some examples, the prediction controller 148 can maintain the data structure 300 as a list of store entries, with each store entry corresponding to the format discussed with respect to FIG. 3A. The data structure 300 can be populated with stores either by directly storing the stores without modification or can decode the store, identify a type of addressing being used by the store and creating a store entry based on the information in the store, for example, as depicted in FIG. 3A. In some implementations, first a store can be classified into a type then extract the information on the store to create an entry within the table. For example, can classify a memfile-type, extract base (RAX), index (NULL-not-present), scale=1, displacement=0), and save the information into an entry within a table. In some examples, the table can be a circular buffer, for example a FIFO buffer implemented with an array. Each new entry is saved into the entry pointed by the youngest pointer, then moves the youngest pointer. The youngest pointer can also wrap from array position 15 back to 0 (in a 16 entry array). For example, in a 16-entry buffer, a first store is placed into entry 1, the second store is placed into entry 2, and continues until seventeenth store is received, which is placed in entry 1.

The illustrative data structure 300 provided in FIG. 3B depicts a data structure having five entries with three different memory addressing methods (e.g., Type A, Type B, Type C). Continuing the above example, the Type A could be associated with a memory file predictor, Type B could be associated with a stack tracker predictor, and Type C could be associated with a rip relative predictor. TABLE 1 below provides an example of stores that could be included in the entries for FIG. 3B.

### TABLE 1

0. MOV [RBX], RAX
   //stores the value in the RAX register into the memory location pointed to by the RBX register//
1. MOV [R10+12], RAX
   //stores the value in the RAX register into the memory location pointed to by the R10 register with an offset of 8//
2. MOV [RBX+RCX*8+16], RAX
   //stores the value in the RAX register into the memory location calculated by taking the base address in the RBX register, an index in RCX scaled by 8, and a displacement of 16//
3. MOV [RIP+1000], R10
   //stores the value in the R10 register into the memory location offset by 1000 bytes from a current value of the current instruction pointer (RIP)//
4. MOV [RBX+8], RAX
   //stores the value in the RAX register into the memory location pointed to by the RBX register with an offset of 8//

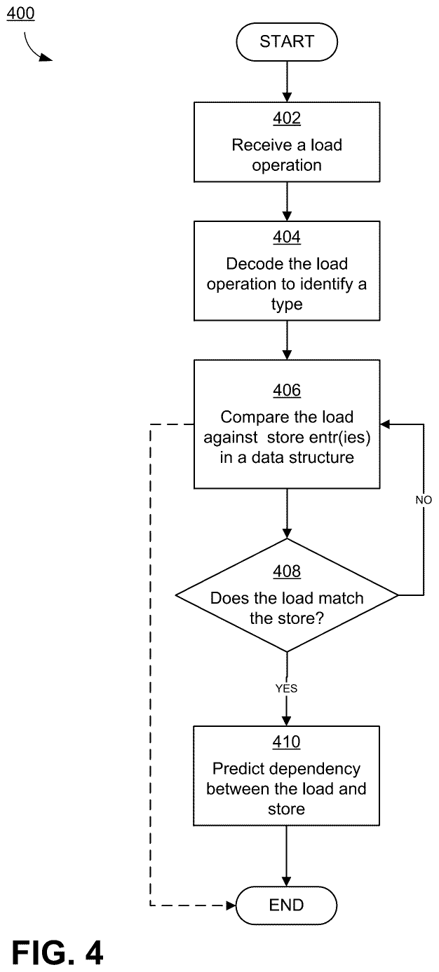

The stores in TABLE 1 would be used to populate the entries in the data structure 300 depicted in FIG. 3B, for example, using the method discussed with respect to FIG. 4.

In some examples, the stores in TABLE 1 can be compared against dispatched load operations for the purposes of memory dependence prediction. Load operations can include any combination of instructions or accesses that are requesting access to data stored in memory (e.g., registers, caches, memory, etc.). An example of a load operation is provided below:
MOV RCX, [RBX]
   //loads the value from the memory location pointed to by RBX into the RCX register//

The load entry for this would include a type for a memory file predictor (e.g., type ‘01’) and the attributes associated with memory file predictors (e.g., base-register, index-register, scale, displacement). When comparing this load example to the stores in TABLE 1, there would be a type match and attributes match between the load and the store at ‘0.’ such that a dependency could be inferred. While not provided in this example, similar to the store examples, loads can also use base registers, index registers, scale, displacement, offset, target address hash values. In some examples, a matching operation can be used to compare an overall value for each entry within a table. For example, when using an entry format including a 2-bit type field 302 and a 20-bit attributes field 304, the matching operation would be comparing a 22-bit value. In particular, a comparison between load and store entries happens a as a comparison of their respective 22-bit values, such that there is not a need to separately compare a type and the type specific attributes. The 22-bit value can effectively represent a signature of the load and stores, such that when their signature match, the store is a candidate for the load. Thereafter, a prediction can be made that the load will get forwarding from the youngest candidate. In alternative examples, the load can be decoded into a type and extract type specific data and can be compared against the table that contains stores. In some examples, when there are multiple matches in the table for a given load, the youngest matched entry (mostly recently added the entry) can be selected.

Referring to FIG. 4, an example flowchart showing an example method for comparing a load entry to store one or more entries within a data structure is depicted. Although the steps of FIG. 4 are discussed with respect to the prediction controller 148, any combination of elements within computer system 100 could be utilized to implement the steps. Initially, a CPU 102 can fetch the next instruction from a program counter or other pipeline, decode the instruction, and then execute the instruction. The instructions can include any combination of store and load instructions. In some examples, once a store instruction has been dispatched for execution by the CPU 102, the store instruction can be added to a data structure, for example, as discussed with respect to FIGS. 2-3B. Thereafter, the prediction controller 148 can operate with the CPU 102 to perform the steps in FIG. 4, as it relates to the load instructions.

At step 402, a load operation is received or otherwise decoded by the prediction controller 148. For example, a load instruction can be received from the CPU 102 as the instruction pipeline for the CPU 102 is populated and/or executed. An example of a load instruction can be MOV RCX, [RBX], which loads the value from the memory location pointed to by RBX into the RCX register. The load operation received by the prediction controller 148 can be an instruction that is currently being executed, is queued to be executed (e.g., dispatched), and/or will be executed shortly.

At step 404, the load operation is decoded or otherwise analyzed, by the prediction controller 148, to identify a type of addressing being used in the load operation. Different types of addressing modes can be used to dictate how the operands of a store instruction are access. For example, in assembly, types of load instructions can be similar to those discussed with respect to the store instructions. The load instruction can be parsed by taking the bytes and transforming them into pieces of information, by the prediction controller 148 (or Instruction Decode Unit), to identify the operands (e.g., source and destination) being used including any additional attributes that can be identified (e.g., base register, index register, offset, scale, displacement, etc.). For example, the store of MOV RCX, [RBX] could be identified as register addressing because both operands are registers (e.g., RCX and RBX).

At step 406, the load is compared, by the prediction controller 148, against the store entr(ies) within a data structure (e.g., the data structure discussed with respect to FIGS. 2 and 3B). The comparison can start with the first store entry in the data structure, and progress as needed through the entries until a complete match (e.g., type and attributes) is found or until all of the entries within the data structure have been compared with the load entry. The comparison can be performed using any combination of techniques to identify matches between types. In some examples, the comparison can be a comparison of all the bits within each of the entries. For example, for an entry having a 2-bit type field and a 20-bit attribute field, a comparison of all 22-bits is performed. The number of bits can vary depending on the size and format of the data structure.

In alternative examples, the fields can be separately compared in an incremental process. For example, the types can be 2-bit values that are compared to determine if two types have the same 2-bit values. For example, a load entry can have a type bit value of ‘01’ and the prediction controller 148 will only match other store entries having a same type bit value of ‘01’. Thereafter, if a type matches, then the attribute fields can be compared. For example, a load entry can have a 20-bit value defining the attribute(s) of the load operation, and the prediction controller 148 will only match other store entries having a same 20-bit value.

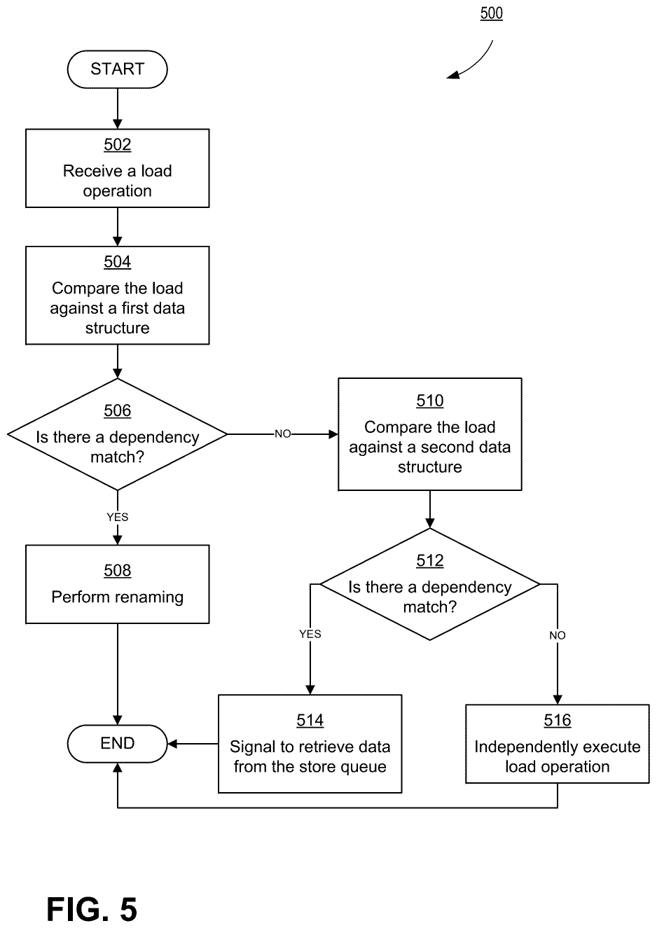

At step 408, based on the comparison performed by the prediction controller 148 at step 406, the prediction controller 148 will perform the appropriate next step. If the load entry matches with a store entry being compared at step 406, then the prediction controller 148 will advance to step 410, otherwise if the types do not match, then the prediction controller 148 will return to step 406 to compare the type in the load entry to the type in the next store entry within the data structure. Additionally, the prediction controller 148 can track a position of the store entry within the data structure or which store entry within the data structure is currently being checked. If the store entry being compared, is the last store entry in the data structure, the prediction controller 148 can determine that there is no dependency between the load entry and the store entr(ies) within the data structure. In some examples, when no more store entries are available for comparison, the prediction controller 148 can branch to the END and/or advance to another flow for additional processing, for example, step 510 of FIG. 5.

In some examples, the comparison performed in step 408 can be performed for every store entry within the data structure, prior to advancing to step 410, such that multiple matches can be identified.

For example:

A fist store (St1) is dispatched, then a second store (St2) is dispatched at a later point in time. Both St1 and St2 would be added as entries into the data structure, as shown below.

$$Mov [ Rbx + 10 ] , RAX < -- St 1$$

$$MOV [ R 10 + 12 ] , RAX$$

$$Mov [ Rbx + 10 ] , RAX < -- St 2$$

Thereafter, continuing the example, a load (L1: Mov RCX, [Rbx+10]) is dispatched and it is compared against each of the stores in the data structure. The load L1 would match against both entries for St1 and St2. In some examples, both matches can be provided as part of the analysis in step 410.

At step 410, if the comparisons at step 406 and 408 have indicated that the load entry and store entry match, a memory dependence prediction can be designated. The memory dependence prediction designation can be a prediction that the memory addresses involved in both the load entry and the store entry will depend on a result of the store within the store entry, for example, when the store is part of a program execution flow. The prediction controller 148 can provide the memory dependence prediction designation to the CPU 102, which will respond accordingly. Thereafter, the CPU 102 can take appropriate action, depending on the processing architecture. For example, the CPU 102 can be speculatively forward the value from the store entry (e.g., data in the attribute field) to the load instruction associated with the load entry such that the load instruction can execute, even if the store has not completed yet. Renaming is one type of speculation, where the operand dependent on the load result is marked to be dependent on the store operand. For example:

RBX:= <some really slow computation> ...
RAX:= 10
....
MOV [RBX], RAX
MOV RCX, [RBX]
.....
ADD R15, R15, RCX,
....

When a prediction is made that a MOV RCX, [RBX] load gets data forwarding from a MOV [RBX], RAX store, and the store is allowed to be renamed, then R15=R15+RCX can be essentially transformed to R15=R15+RAX. As a result of the prediction and renaming, all the RBX computation can be skipped without causing issues. While plain forwarding from a store, the ADD R15, R15, RCX is not transformed into ADD R15, RAX, execution for the MOV RCX, [RBX] instruction is sped up, possibly before the RBX value is known.

When more than one matches (e.g., two entries having a same type and same information) have been provided from step 408, the prediction controller 148 can perform additional processing. In some examples, the prediction controller 148 will find the youngest older match by determining which matched entry is the youngest store. For example, in the above example for St1, St2, and L1, the youngest older match would be St2. The prediction controller 148 can identify the youngest store using any combination of methods. For example, in a circular FIFO, the prediction controller 148 can first search from entry N down to entry 1 to find a match, if no match is found, the prediction controller 148 can search from entry 15 down to entry N+1 to find a match. In some examples, the process for identifying the youngest older match could be performed as part of step 408, such that only one match is provided to step 410 or it can be performed at step 410.

Referring to FIG. 5, an example flowchart showing an example method for comparing a load entry to store entr(ies) within a data structure having multiple levels is depicted. In some examples, the prediction controller 148 and/or the load/store storage controller 152 can maintain data structure having a first part including the most recent stores and a second part including older stores. The first part and second part of the data structure can include any combination of buffers, tables, lists, etc. For example, the first part can be an active store table that temporarily maintains store instructions that are in progress or have been initiated but not yet been completed and the second part can be a store queue that temporarily maintains store instructions waiting to be executed. In some examples, the data structure(s) can be stored by the load/store storage controller 152 and/or within the memory subsystem of the CPU 102 (e.g., L1 cache). Examples of the first part and second part of the data structure are discussed in greater detail with respect to FIG. 6. Although the steps of FIG. 5 are discussed with respect to the prediction controller 148, any combination of elements within computer system 100 could be utilized to implement the steps.

At step 502, a load operation is received or otherwise decoded by the prediction controller 148. For example, a load instruction can be received from the CPU 102 as the instruction pipeline is populated and/or executed. An example of a load instruction can be MOV RCX, [RBX], which loads the value from the memory location pointed to by RBX into the RCX register. The load operation received by the prediction controller 148 can be an instruction that is currently being executed, is queued to be executed (e.g., dispatched), and/or will be executed shortly.

At step 504, the data within the load operation is compared to data within one or more store operations stored within a first part of the data structure, for example, an active store table. In particular, a comparison is performed to determine a probability that the load operation depends on a store instruction within the first data structure. In some examples, the comparison is a syntactical comparison to determine whether any of the store operations are similarly structured to the load operation. The comparison can include any combination of comparison methods, for example, the method discussed with respect to FIG. 4. In some examples, the comparison can repeat until a match is found or until all of the entries within the first data structure have been compared with the load operation.

At step 506, based on the result of the comparison performed by the prediction controller 148 at step 504, the prediction controller 148 will perform the appropriate next step. If the load operation sufficiently matches with the store operation to indicate a memory dependence exists, at step 506, then the prediction controller 148 will advance to step 508, otherwise if a memory dependence does not exist (e.g., not sufficiently matching), then the prediction controller 148 will advance to step 510 to compare the load operation to the store operations within a second part of the data structure, for example, a store queue. A sufficient match can vary based on any combination of system requirements, user preferences, etc. For example, sufficiently matching can require an exact match (e.g., 22-bits of the load is a 1-to-1 match of the 22-bit of the store) or it can be within a predetermined threshold (e.g., a percentage of the 22-bits of the load overlap with the 22-bit of the store).

At step 508, if there is a dependency match, as determined by the prediction controller 148, then a renaming process can be initiated. For example, if the type and attributes of the load operation and store operation are a sufficient match to satisfy a memory dependence prediction threshold, then the value of the load operation can be renamed to the matching store operation. In some implementations, one condition to rename a load operation against a store is that a store operation has a SRN. For example, entries 606 in the first data structure 602 of FIG. 5 have an implicit SRN, such that a match an entry 606 can cause a load operation to be renamed. In some examples, memory renaming can include assigning a temporary alias to the memory location in the matching memory store operation (that matches the load operation). The temporary alias can enable the load operation to be speculatively executed earlier in the pipeline without waiting for the store operation from which it depends to complete, thus potentially improving performance by reducing stalls due to data dependencies.

At step 510, the data within the load operation is compared to data within one or more store operations stored within the second data structure. In particular, a comparison is performed to determine a probability that the load operation depends on a store instruction within the second data structure. In some examples, the comparison is a syntactical comparison to determine whether any of the store operations are similarly structured. The comparison can include any combination of comparison methods, for example, the method discussed with respect to FIG. 4. In some examples, the comparison can repeat until a match is found or until all of the entries within the second data structure have been compared with the load operation.

At step 512, based on the result of the comparison performed by the prediction controller 148 at step 510, the prediction controller 148 will perform the appropriate next step. If the load operation sufficiently matches with the store operation to indicate a dependency exists, at step 510, then the prediction controller 148 will advance to step 514, otherwise if a dependency does not exist (e.g., not sufficiently matching), then the prediction controller 148 will advance to step 516 to execute the load operation as an independent instruction.

At step 514, prediction controller 148 can signal the CPU 102 to retrieve data from the store queue for use by the load operation. In particular, the CPU 102 may forward the data from the matching store in the store queue to the load operation. This operation allows loads to get data from the store queue rather than waiting for the store to complete in memory. In some examples, the data being retrieved would include a store register number or pointer to a store register number for the matching store operation from the second data structure. While this prediction may not be as efficient as the renaming process at step 508, this secondary prediction is still providing an improvement over in order processing by providing a second level of predictions because the load will not have to retrieve data from memory.

At step 516, the prediction controller 148 can signal to the CPU 102 that the load operation can be executed as an independent instruction because there is no dependency on a store operation in either of the first data structure or the second data structure. In other words, an independent load instruction can be executed out of order.

Although the process 500 shows an end, in some examples, additional processing can be performed. For example, renaming and dependency prediction can be wrong, logic can be implemented to check the rename decision and/or dependency prediction to detect exceptional cases. In those situations, the system may “roll back” the speculative execution state to a non-speculative state.

Referring to FIG. 6, an illustration of a data structure for storing store operations recently dispatched for execution is depicted. The data structures provided in FIG. 6 can be created using any combination of methods, such as the method discussed with respect to FIGS. 2-3B. Similarly, the data structures provided in FIG. 6 can be used for memory prediction using any combination of methods, such as the method discussed with respect to FIGS. 4 and 5. The data structure can include any combination of buffers, tables, lists, etc. and can be a single structure or multiple data structures.

In some implementations, the data structure can include two data structures or parts including a first data structure 602 and a second data structure 604 that are used to perform memory prediction for retrieving data from different locations based on a recency of the store entries included within those data structures. The first data structure 602 can include the most recent store entries 606 and can be used to for memory prediction renaming to retrieve data from the store register. For example, the first data structure 602 can be an active store table including the 16 most recent set of store entries 606 that are in progress or have been initiated but not yet been completed, as depicted in FIG. 6. In some examples, once store data from the first data structure 602 is written to memory, it is invalidated and/or removed from the first data structure 602. The second data structure 604 can include the next most recent store entries 608 (e.g., the store entries most recently removed from the first data structure 602) and can be used to for memory prediction. For example, the second data structure 604 can be a store queue that temporarily maintains the 16 next most recent set of store entries 608 waiting to be executed, as depicted in FIG. 6. For example, entry X from first data structure 602 can be copied to entry X of the second data structure 602, when entry X is written into by a new store. It may not be necessary to write invalidated entries from the first data structure 602, but it may be easier for implementation. In some examples, the first data structure 602 and second data structure 604 can be stored by the load/store storage controller 152 and/or within the memory subsystem of the CPU 102 (e.g., L1 cache).

In some examples, each of the first data structure 602 and the second data structure 604 can be created in a similar manner. For example, as store operations are read from an instruction pipeline, they can be added to the first data structure 602. Once the first data structure 602 has been filled (e.g., with 16 entries), the next received store entry will cause the least recent store entry to be automatically deallocate and removed from the first data structure 602 such that no longer eligible for memory renaming. The removed store entries will then be added to the second data structure 604 which is limited to memory dependency prediction but not renaming.

In some examples, each of the first data structure 602 and the second data structure 604 are created using a first in first out (FIFO) methodology. The use of a fixed mapping FIFO (where an entry 0 receives a store register number 0 and an entry 15 receives a store register number 15) helps with timing while building deeper data structures for better performance, with reduced area, and improved power efficiency. All of the store entries in each of the first data structure 602 and the second data structure 604 includes sufficient information about the dispatched store to support memory dependency prediction and/or memory renaming. In other words, each of the first data structure 602 and the second data structure 604 include similar data (e.g., store entries) such that the comparison for memory prediction is performed in a similar manner.

In operation, the first data structure 602 and the second data structure 604 provided in FIG. 6 creates a data structure in which Content-addressable memory (CAM) is performed against a data structure including multiple different types of memory addressing, which require different memory dependence prediction methods. The CAM process compares load operation data against a table of store entries and returns the address of any matching entries. When the address matches, depending which data structure 602, 604 includes the match the corresponding function is performed (e.g., renaming or store queue pointer) to fetch content from cache memory.

It can be computationally expensive to perform memory renaming, and when renaming is incorrect it can be costly (e.g., power, performance) to recover. The second data structure 604 provides a way to improve performance, although it is not always as beneficial as memory renaming. However, the second data structure 604 provides another level of memory dependence prediction that avoids the potential downside of wrong memory renaming. For example, to support memory renaming, the renaming decision is made in an earlier dispatch pipeline stage, while memory dependency prediction can be made in a later pipeline stage. As a result, more memory dependency prediction can be performed by doing the comparison over two cycles. For example, the process effectively can take two cycles to find a match in the first data structure 602 in cycle n and in the second data structure 604 provides a match in cycle n+1. Performing memory dependency prediction over two cycles is not only good for timing, but also good for power because most forwarding happens between a close-by store. For example, if a match is found in the first data structure 602 then there is no searching performed for a match in the second data structure 604, thus saving the power.

Techniques operating according to the principles described herein can be implemented in any suitable manner. While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality. While FIG. 6 depicts a first data structure 602 and a second data structure 604, each including 16 entries, any number of data structures could be implemented using any number of entries without departing from the scope of the present disclosure.

Included in the discussion above are flowcharts showing steps and acts of processes that perform memory dependence prediction. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and implementations of the principles described herein.

Accordingly, in some implementations, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative implementations, be adapted to interact with other, unrelated functional facilities and/or processes, to implement a software program application. In other implementations, the functional facilities can be adapted to interact with other functional facilities in such a way as form an operating system, including the Windows^{®}operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that implementations are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some implementations, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory 126, accelerator memory 138, and/or storage 146 of the computer system 100 of FIG. 1 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Implementations have been described where the techniques are implemented in circuitry and/or computer-executable instructions. It should be appreciated that some implementations may be in the form of a method, of which at least one example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

Various aspects of the implementations described above may be used alone, in combination, or in a variety of arrangements not specifically discussed in the implementations described in the foregoing and is therefore not limited in its application to the details and arrangement of components set forth in the foregoing description or illustrated in the drawings. For example, aspects described in one embodiment may be combined in any manner with aspects described in other implementations.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method for memory dependency prediction, the method comprising:
maintaining, by processing circuitry, a set of store instructions recently dispatched for execution, each store instruction having a type and one or more attributes; and
in response to identifying a load instruction having a first type and a first set of one or more attributes that correspond to a store instruction in the set of store instructions recently dispatched for execution, indicating, by the processing circuitry, a memory dependency between the load instruction and the store instruction.

2. The method of claim 1, wherein the indicating the memory dependency is performed using a memory dependence prediction methodology associated with the first type.

3. The method of claim 1, wherein the set of store instructions recently dispatched for execution includes a list of stores having multiple types of memory addressing structures.

4. The method of claim 1, wherein:
the first type is associated with a symbolic file addressing structure; and
the first set of one or more attributes are at least a base register, an index register, a scale, and a displacement.

5. The method of claim 1, wherein:
the first type is associated with a stack addressing structure; and
the first set of one or more attributes is at least an offset.

6. The method of claim 1, wherein:
the first type is associated with a rip relative addressing structure; and
the first set of one or more attributes is at least a target address hash.

7. The method of claim 1, wherein the maintaining the set of store instructions recently dispatched for execution comprises:
a first table having a first plurality of store instructions that have most recently been dispatched; and
a second table having a second plurality of store instructions that have most recently been removed from the first table.

8. The method of claim 7, wherein the indicating the memory dependency comprises:
matching the first set of one or more attributes to the store instruction within the first table having the first plurality of store instructions; and
renaming the store instruction within the first table of the set.

9. The method of claim 7, wherein the indicating the memory dependency comprises:
matching the first set of one or more attributes to the store instruction within the second table having the second plurality of store instructions; and
retrieving data from a store queue entry using information from the second table.

10. A system comprising:
at least one storage medium having encoded thereon executable instructions;
at least one processing unit configured to interact with the executable instructions and configured to:
maintain a set of store instructions recently dispatched for execution, each store instruction having a type and one or more attributes; and
in response to identifying a load instruction having a first type and a first set of one or more attributes that correspond to a store instruction in the set of store instructions recently dispatched for execution, indicate a memory dependency between the load instruction and the store instruction.

11. The system of claim 10, wherein the at least one storage medium includes at least one of registers, cache, and random-access memory.

12. The system of claim 10, wherein the indicating the memory dependency is performed using a memory dependence prediction methodology associated with the first type.

13. The system of claim 10, wherein the set of store instructions recently dispatched for execution includes a list of stores having multiple types of memory addressing structures.

14. The system of claim 10, wherein the maintaining the set of store instructions recently dispatched for execution comprises:
a first table having a first plurality of store instructions that have most recently been dispatched; and
a second table having a second plurality of store instructions that have most recently been removed from the first table.

15. The system of claim 14, wherein the indicating the memory dependency comprises:
matching the first set of one or more attributes to the store instruction within the first table having the first plurality of store instructions; and
renaming the store instruction within the first table of the set.

16. An apparatus comprising:
at least one circuit arranged to:
maintain a set of store instructions recently dispatched for execution, each store instruction having a type and one or more attributes; and
in response to identifying a load instruction having a first type and a first set of one or more attributes that corresponds to a store instruction in the set of store instructions recently dispatched for execution, indicate a memory dependency between the load instruction and the store instruction.

17. The apparatus of claim 16, wherein the indicating the memory dependency is performed using a memory dependence prediction methodology associated with the first type.

18. The apparatus of claim 16, wherein the set of store instructions recently dispatched for execution includes a list of stores having multiple types of memory addressing structures.

19. The apparatus of claim 16, wherein the maintaining the set of store instructions recently dispatched for execution comprises:
a first table having a first plurality of store instructions that have most recently been dispatched; and
a second table having a second plurality of store instructions that have most recently been removed from the first table.

20. The apparatus of claim 16, wherein the circuit is one of one or more central processing units (CPUs), one or more processor chiplets of the one or more CPUs, and one or more cores of a processor chiplet.
